(19) United States
(12) Patent Application Publication
(10) Pub. No.: US 2017/0206505 A1
(43) Pub. Date: Jul. 20, 2017

(54) MEDICATION REMINDER DEVICE

(71) Applicant: Cosburne O. Wright, Fort Lauderdale, FL (US)

(72) Inventor: Cosburne O. Wright, Fort Lauderdale, FL (US)

(21) Appl. No.: 15/406,401

(22) Filed: Jan. 13, 2017

Related U.S. Application Data
(60) Provisional application No. 62/280,944, filed on Jan. 20, 2016.

(51) Int. Cl. G06Q 10/10; A61J 7/04; G06F 19/00

(52) U.S. Cl. CPC G06Q 10/1093; G06F 19/3456; A61J 7/04; A61J 7/0481; A61J 2200/70

(57) ABSTRACT

The present invention is a medication reminder device that has wristwatch-style straps, a control panel utilized as an electronic notification device stylized as a wristwatch face, and a compartment capable of holding a plurality of medication. The first strap comprises a fastener such as a buckle. The control panel comprises a display screen, a speaker, a vibration module, an indicator light, a reset button, and a set button. The control panel also includes a timer circuit, further having a calendar, a clock, a scheduling function, and alarm activation. The calendar function may comprise day of the week selections. The clock functionality may comprise hour, minute, and AM and PM selections

### RELATED APPLICATIONS

This application claims the priority date of Provisional Application No. 62/280,944 filed on Jan. 25, 2016.

### FIELD OF THE INVENTION

The present invention relates generally to the field of prescription administration scheduling devices and more specifically relates to a medication reminder system.

### BACKGROUND FOR THE INVENTION

Medications are chemicals or compounds used to cure, halt, or prevent disease, or to ease symptoms such as chronic pain. Medications may also be prescribed to maintain a parameter, such as blood pressure or insulin level, within acceptable limits. As the population ages, chronic medical conditions tend to accumulate and persons of a certain age may require multiple medications to treat a number of medical conditions. For medications to be safe and effective, they must be taken at a particular dosage, at specified times, and for a specific period of time. As the number of medications a patient requires increases, care must be taken to ensure that the administration of one (1) medication does not negatively impact the efficacy of another medication.

There are many reasons why patients don't receive medications as prescribed. A patient, for example, may perceive that the medication has caused, or will cause, some adverse event, is confused about why and how to take the medication, or finds it inconvenient to take the medication. Therefore, caregivers often participate in administering patient medication. Caregivers are the link between a patient and the prescribing doctor with a goal of ensuring proper dosage and accurate timing of doses to ensure that the patient has consistent quantities of medicine. Tracking of when a next dose needs to be administered can be challenging, especially if the patient takes multiple medications at different times. A suitable solution is desired.

Various attempts have been made to solve problems found in medication reminder means art. Among these are found in: U.S. Pat. and Pat. App. Pub. Nos. 2009/0086579 to Clark; 2009/0040874 to Rooney et. al.; 6,340,242 to Sandidge; 2015/0235004 to Shor, et. al.; 6,075,755 to Zarchan; and 5,157,640 to Backner. These prior art references are representative of prescription administration scheduling devices.

None of the above inventions and patents, taken either singly or in combination, is seen to describe the invention as claimed. Thus, a need exists for a reliable medication reminder system, and to avoid the above-mentioned problems.

### SUMMARY

The present invention is a medication reminder device. It comprises wristwatch-style straps, a control panel utilized as an electronic notification device stylized as a wristwatch face, and a compartment capable of holding a plurality of medication. The first strap comprises a fastener such as a buckle. The second strap comprises a plurality of apertures, each aligned with each other about a longitudinal bisecting center line.

The control panel comprises a display screen, a speaker, a vibration module, an indicator light, a reset button, and a set button.

The current invention is an improvement over prior art.

### DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a medication reminder system 10, according to an embodiment of the present invention; and

FIG. 2 is an internal view showing vibration and battery components.

### ITEM TERMS

10 medication reminder device
20 device body
30 first strap
31 buckle
35 second strap
36 aperture
40 display
41 speaker
42 indicator light
50 reset button
51 set button
60 medication compartment
61 medication compartment lid
77 medication
80 vibration module
85 battery powering means

### DESCRIPTION OF THE INVENTION

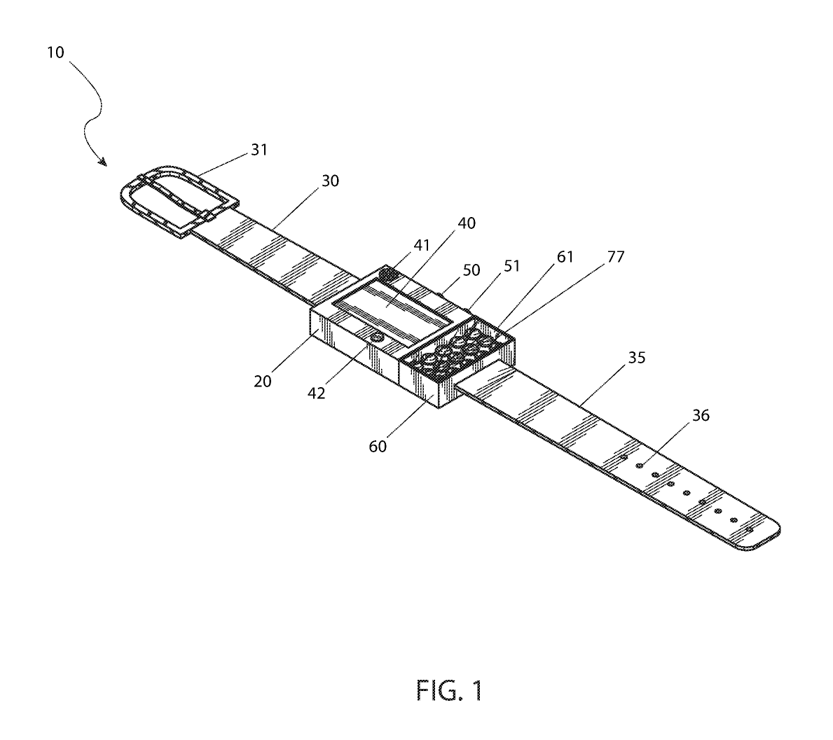

The best mode for carrying out the invention is presented in terms of its preferred embodiment, herein depicted within FIG. 1. However, the invention is not limited to the described embodiment, and a person skilled in the art will appreciate that many other embodiments of the invention are possible without deviating from the basic concept of the invention and that any such work around will also fall under the scope of this invention. It is envisioned that other styles and configurations of the present invention can be easily incorporated into the teachings of the present invention, and only one (1) particular configuration shall be shown and described for purposes of clarity and disclosure and not by way of limitation of scope.

The terms “a” and “an” herein do not denote a limitation of quantity, but rather denote the presence of at least one (1) of the referenced items.

The present invention is directed to a medication reminder device 10. In one (1) embodiment of the present invention, a medication reminder device 10 may comprise wristwatch-style straps 30, 35, a control panel utilized as an electronic notification device stylized as a wristwatch face, and a compartment 60 capable of holding a plurality of medication 77 therein.

Referring now to the drawings, there is shown in FIG. 1 a medication reminder device 10, comprising a device body 20 with wristwatch-style straps 30, 35 extending away therefrom, and a control panel utilized as an electronic notification device. The watch-style straps 30, 35 may comprise a plurality of durable materials and a connection means such as a buckle and fastener. The durable materials may withstand multiple wearing and cleanings. The first strap 30 may comprise a fastener such as a buckle 31. The second strap 35 may comprise a plurality of apertures 36, each aligned with each other about a longitudinal bisecting center line. The buckle 31 may be structured and arranged to repeatedly coupled with a desired aperture 36. The device body 20 has affixed to it a compartment 60, which may be fabricated as a unitary device. This unitary device 20, 60 may be removably coupled to the straps 30, 35.

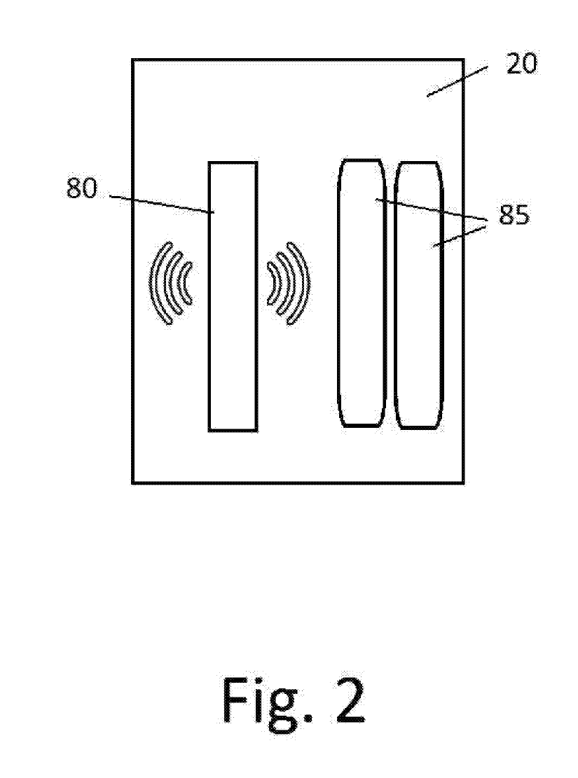

In continuing to refer to FIG. 1, the control panel may comprise a display screen 40, a speaker 45, a vibration module 80 (FIG. 2), an indicator light 42, a reset button 50, and a set button 51. The internal components may comprise circuitry, programming, and battery powering means 85 to accomplish electronic notification device functions. The body/compartment 20, 60 may comprise a housing structured and arranged to be removably coupled to the strap 30, 35. The reset button 50 and set button 51 may comprise momentary contact pushbuttons.

The control panel may also further comprise a power pushbutton, a menu pushbutton, and an end pushbutton. The power pushbutton may comprise a means to apply or remove power to the electronic notification device. When power is applied to the control panel, the device remains in an “on” condition until the power pushbutton is pressed again. The menu pushbutton may comprise a means to activate a plurality of functions.

The control panel also includes a timer circuit, further having a calendar, a clock, a scheduling function, and alarm activation. The calendar function may comprise day of the week selections. The clock functionality may comprise hour, minute, and AM and PM selections. The scheduling function may comprise a plurality of scheduling notifications. Scheduling notification functions may comprise day, date, time, AM or PM, and a plurality of medication identifiers. The plurality of medication identifiers may comprise identification types whereby a user may knowledgably associate the identification type to a prescribed medication. The alarm activation function may comprise enablement of an audible notification projected through said speaker 41, activation of a vibration module 80, and activation of an indicator light 42. The set button 51 may comprise an internal signal that programming of scheduling notification functions is complete. The reset button 50 may comprise an internal signal to reactivate scheduling notification functions. The end pushbutton may comprise acknowledgement means of the alarm activation function and disabling of the audible notification through the speaker 41, the vibration module, and activation of the indicator light 42.

In further referring to FIG. 1, the display screen 40 may comprise a digital display, which may comprise a representation of the seven days of the week, an alarm activation function status, an hour, a minute, and an AM or PM display. The seven days of the week representation may comprise the seven days of the week, arranged in order from Sunday through Saturday. The seven days of the week representation may further comprise an indicator of the current day.

In continuing to refer to FIG. 1, the electronic notification device 10 may comprise a speaker 41. The speaker 41 may comprise an audible notification based on alarm activation function programming. The audible notification may comprise a chime, a beeper, a tone, or a verbal command. The verbal command may comprise the words “meds time”. The vibration module notification 80 may comprise an oscillation motion. The oscillation motion may be initiated by alarm activation function programming. The indicator light 42 may comprise an light-emitting diode (LED) light. The indicator light 42 may be initiated by alarm activation function programming. The compartment 60 may comprise a receiving body in which medication 77 may be securely held. A lid 61 effectively closes the compartment 60 to secure the medication 77 therein. The lid 61 may have a lock.

Additional embodiments of the present invention may comprise a portable device suitable for hand-carrying, a clip-on device suitable for attaching to clothing, and an attachment means suitable for attaching to a keychain. Further, additional embodiments of the device 10 may comprise a touch-screen interface or mobile-device application. A method of using a medication reminder system may comprise turning the medication reminder system on; setting the current day, time, AM or PM, scheduling notifications; enabling alarm activation functions; deactivating audible notification, vibration module notification, and illumination module notifications; resetting initiation of scheduling notification functions; and retrieving medication 77 from the closed compartment 60. The method of use may further comprise use by a patient or a caregiver. The exact specifications, materials used, and method of use of the medication reminder device may vary upon manufacturing.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A medication reminder device, comprising:
a device body, having a first end and a second end;
a compartment capable of holding a plurality of medication therein, affixed to said device body;
a lid removably attached to an upper opening of said compartment;
a control panel, comprising:
a display located on a top surface of said device body;
a speaker located on said top surface of said device body;
an indicator light located on said top surface of said device body;
a reset button located on a side surface of said device body;
a set button located on said side surface of said device body;
a timing circuit; and a control module in electrical communication between a power source and said display, said speaker, said indicator light, said reset button, and said set button;
a first strap extending away from a first side of said device body, terminating in a buckle;
and, a second strap extending away from said second side of said device body, further having a plurality of apertures aligned longitudinally about a center bisecting line thereof;
wherein said buckle is capable of securing to any one of said plurality of apertures.

2. The device of claim 1, wherein said device body and said compartment are a unitary construction.

3. The device of claim 1, wherein said timer circuit also includes a calendar.

4. The device of claim 1, wherein said timer circuit also includes an audible alarm.

5. The device of claim 1, wherein said timer circuit also includes a scheduling function.

6. The device of claim 1, further comprising a vibration module in electrical communication with said control module.

7. The device of claim 1, further comprising where the power source is a plurality of batteries.

8. The device of claim 5, further comprising having the scheduling function set the current day, time, AM or PM, scheduling notifications; enabling alarm activation functions; deactivating audible notification, vibration module notification, and illumination module notifications; resetting initiation of scheduling notification functions; and retrieving medication from the closed compartment.

9. The device of claim 1, further comprising where the indicator light is an light-emitting diode (LED) light.

10. The device of claim 1, further comprising where the lid has a lock.

11. A medication reminder device, comprising:
a device body, having a first end and a second end;
a compartment capable of holding a plurality of medication therein, affixed to said device body;
a lid removably attached to an upper opening of said compartment;
a control panel, comprising:
a display located on a top surface of said device body;
a speaker located on said top surface of said device body;
an indicator light located on said top surface of said device body;
a reset button located on a side surface of said device body;
a set button located on said side surface of said device body;
a timing circuit; and a control module in electrical communication between a power source and said display, said speaker, said indicator light, said reset button, and said set button; and an attachment means.

12. The device of claim 11, wherein said device body and said compartment are a unitary construction.

13. The device of claim 11, wherein said timer circuit also includes a calendar.

14. The device of claim 11, wherein said timer circuit also includes an audible alarm.

15. The device of claim 11, wherein said timer circuit also includes a scheduling function.

16. The device of claim 11, further comprising a vibration module in electrical communication with said control module.

17. The device of claim 11, further comprising where the power source is a plurality of batteries.

18. The device of claim 15, further comprising having the scheduling function set the current day, time, AM or PM, scheduling notifications; enabling alarm activation functions; deactivating audible notification, vibration module notification, and illumination module notifications; resetting initiation of scheduling notification functions; and retrieving medication from the closed compartment.

19. The device of claim 11, further comprising where the indicator light is an light-emitting diode (LED) light.

20. The device of claim 11, further comprising where the lid has a lock.
